(19) United States
(12) Patent Application Publication
(10) Pub. No.: US 2025/0242658 A1
(43) Pub. Date: Jul. 31, 2025

(54) Vehicle Monitoring and Safety System

(71) Applicant: Tamir Rosenberg, Stevenson Ranch, CA (US)

(72) Inventor: Tamir Rosenberg, Stevenson Ranch, CA (US)

(21) Appl. No.: 19/035,785

(22) Filed: Jan. 23, 2025

Related U.S. Application Data
(60) Provisional application No. 63/626,910, filed on Jan. 30, 2024.

(51) Int. Cl. B60H 1/00; G06V 20/59; G06V 40/10; G06V 40/16; G08B 21/22; G08B 21/24

(52) U.S. Cl. CPC B60H 1/00742; B60H 1/00807; B60H 1/00828; G06V 20/593; G06V 40/103; G06V 40/178; G08B 21/22; G08B 21/24

(57) ABSTRACT

A vehicle monitoring system is capable of recognizing unattended people and/or animals in a vehicle and sending alerts from the vehicle responsive to environmental conditions within the vehicle. The system is optionally trained to distinguish between adults and people that may not be able to get out of the vehicle on their own, e.g., children or non-ambulatory adults. The vehicle monitoring system is optionally configured to operate within a self-driving car.

### CROSS-REFERENCE TO RELATED APPLICATIONS

This application claims benefit of and priority to U.S. provisional patent application Ser. No. 63/626,910 filed Jan. 30, 2024, the disclosure of which is hereby incorporated herein by reference.

### BACKGROUND

### Field of the invention

The invention is in the field of vehicle safety and specifically the safety of children or animals within a vehicle.

### Related Art

Unfortunately, every year children or pets are left in hot vehicles and die from pediatric heatstroke.

### SUMMARY

A smart monitoring system is capable of distinguishing the types of occupants within a stationary vehicle. Specifically, using a trained machine learning system, the monitoring system can distinguish between adults, children and/or animals. The monitoring system also detects conditions within the vehicle, e.g., temperature. Based on the detection of an unaccompanied child or animal (e.g., presence of a child or animal but not an adult) the system can take corrective measures including but not limited to sending an alert to a remote device and/or venting the vehicle.

Various embodiments of the invention include a vehicle monitoring and safety system, the system comprising an occupant sensor configured to generate sensor data regarding occupants of a vehicle; a trained machine learning system configured to process the sensor data to distinguish between adults, children and animals within the vehicle, a result of the processing including a determination if a child or animal is in the vehicle without an adult, the machine learning system optionally being configured to distinguish a specific occupant based on an identifier of a specific person or animal; a vehicle sensor configured to detect a condition within the vehicle, the condition including at least interior vehicle temperature and/or venting status; optional alert logic configured to send an alert to a remote device based on the condition within the vehicle and the determination that a child or animal is in the vehicle without an adult; and optional venting logic configured to vent the vehicle based on the condition within the vehicle and the determination that a child or animal is in the vehicle without an adult.

Various embodiments of the invention include a method of monitoring vehicle occupants, the method comprising optionally receiving an identifier of a person or animal to be monitored, the identifier optionally including a photograph; using an occupant sensor to generate sensor data regarding an interior of a vehicle, wherein the sensor can include a camera, an ultrasonic sensor, a weight sensor, a lidar sensor or a radar sensor; using a trained machine learning system to process the sensor data, the machine learning system being trained to distinguish between adults, children and/or animals within the sensor data, the machine learning system optionally being trained to detect the person or animal based on the identifier, a result of the processing including a determination if a disabled person, child or animal is in the vehicle without a responsible adult; optionally detecting a condition of the vehicle, the condition including at least one of: interior vehicle temperature, and venting status; if a child or animal is present in the vehicle without an adult optionally performing a venting operation; and if a child or animal is present in the vehicle without an adult optionally sending an alert to a remote device.

### BRIEF DESCRIPTION OF THE DRAWINGS

FIG. 1 illustrates a vehicle monitoring and safety system, according to various embodiments.

FIG. 2 illustrates a method of monitoring vehicle occupants, according to various embodiments.

FIG. 3 illustrates display of a vehicle occupant on a mobile device, according to various embodiments of the invention.

FIG. 4 illustrates communication between a vehicle camera, mobile devices and cloud services, according to various embodiments of the invention.

### DETAILED DESCRIPTION

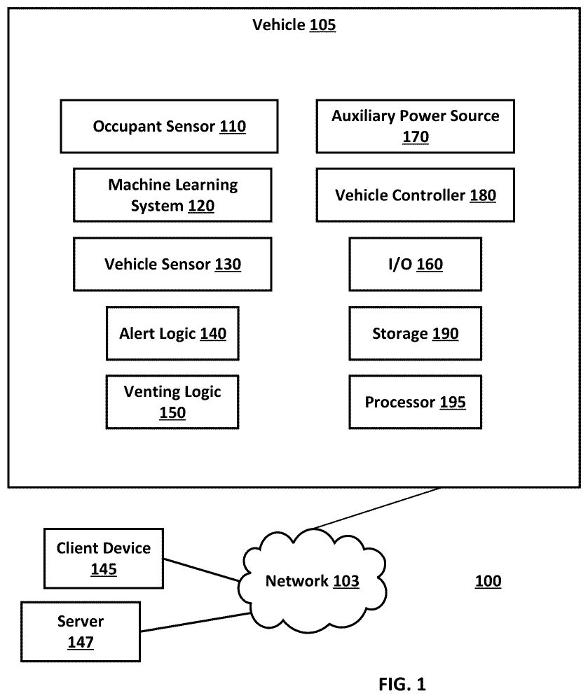

FIG. 1 illustrates a vehicle monitoring and safety system 100, according to various embodiments. System 100 is configured to recognize unattended children and/or animals in a vehicle 105 and depending on conditions within the vehicle 105 take corrective action.

System 100 includes an Occupant Sensor 110. Occupant Sensor 110 is configured to generate sensor data regarding occupants of vehicle 105.

Occupant Sensor 110 may include, for example, a camera sensor that produce an image and/or video, an ultrasonic sensor that send and receive sound waves and produce signals that detect objects in an environment, a lidar sensor that use laser beams to detect the objects in an environment, or a radar sensor that use radio frequencies to send and receive signals and produce data about human movement, breathing or heartbeats.

The sensors can be located in various places in the vehicle, depending on the sensor requirements. In one embodiment the sensors can be installed, but not limited to, in front of the car and pointing back to the vehicle interior. In another embodiment, the sensors can be installed, but not limited to, at the ceiling of the vehicle, pointing at the vehicle interior from the top. In another embodiment, but not limited to, the sensor can be included in the front driver mirror or included in a special mount above the mirror, or a special mount at the ceiling of the vehicle. In another embodiment, but not limited to, the sensor can be installed in an after-market device that will be mounted in the interior of the vehicle, near the front driver mirror, by mounting the sensor to the mirror or the windshield.

Vehicle 105 may further include an Input/Output (I/O 160) configured to communicate to external devices via a network 103. Network 103 can include, for example, a wireless network, a cellular network, a WiFi network, Bluetooth, etc. The external devices can include a remote server 147 or a client device 145. Client device 145 may include a smartphone, wearable or other computing device. Any of the elements illustrated in FIG. 1 as being included in Vehicle 105 may alternatively be located, at least in part, within the external devices. I/O 160 is optionally configured for Vehicle-to-Vehicle (V2V), Vehicle-to-Pedestrian (V2P) or Vehicle-to-Infrastructure (V2I) communication.

System 100 further includes a trained Machine Learning System 120. Machine Learning System 120 is configured to process the sensor data produced using occupant sensor 110 to distinguish between adults, children and animals within the vehicle. Note that an “adult” may be defined by a user. For example, Machine Learning System 120 may be set to consider anyone (not disabled) over 8 years old to be an “adult,” as a 9 year old is typically capable of venting a vehicle on their own. The user may be able to set a specific age for what is considered an adult.

The trained Machine Learning System is using at least one model, that is trained using at least one datasets that includes examples of adults, children and animals, and helps the system to distinguish between the objects. The model can be trained with datasets that can include, but not limited to, the object age, which can help the Machine Learning System to use different thresholds based on the age of the object to distinguish between adults and children. These thresholds can be predefined by the Machine Learning System or defined by an input from a user, or by a mix of both.

A result of the processing by Machine Learning System 120 includes a determination if a child or animal is in the vehicle without an adult, For example, Parents/caregivers often unknowingly lock the car and leave their child asleep. The system immediately sends a notification to take action. Another example, a child on a school bus decides to play hide and seek under their seat. The sensor of the invention mounted in the bus detects the child is in the bus alone without the driver or other adult. The system immediately sends a notification to take action.

In some embodiments Machine Learning System 120 is further configured to distinguish a specific occupant based on an identifier of a specific person or animal. For example, the invention can allow the user to customize the recognition capabilities of the system, by providing images to the system of a specific child using, but not limited to, the system installed in the car, the user mobile phone, or the user home computer via a website. In some examples, an identifier is used to designate a disabled person. For example, an elderly (but infirm or handicapped) person may not be able to vent a vehicle on their own, despite being an “adult.” A user may provide a picture of their elderly grandmother or a handicapper sibling as an identifier. Thus, activating the system 100 to manage venting of the vehicle or sending of alerts if this specific person is unattended in hot internal vehicle temperatures.

In some embodiments Machine Learning System 120 is configured for a user to customize the recognition capabilities. For example, a parent may specify that an alert should be sent if an infant is in the vehicle with a two year old sibling but not if the infant is in the vehicle with a ten year old sibling. In these embodiments, Machine Learning System 120 is configured to distinguish between the infant and each of the older siblings.

System 100 further includes a Vehicle Sensor 130. Vehicle Sensor 130 is configured to detect a condition inside and/or outside the vehicle. For example, Vehicle Sensor 130 may detect conditions including at least one of interior vehicle temperature and venting status. For example, when a child is left in a vehicle, the child's temperature can rise fast and can cause heatstroke. The interior vehicle temperature sensor can help to decide when to send notifications and the actions that can be taken, based on the temperature. One of the actions can be, but not limited to, to vent the vehicle by at least one action like, but not limited to, lower the vehicle windows, open the sunroof, turn on the A/C system, and unlock/open the vehicle's doors.

In some embodiments, the external temperature sensor provides information about the outside temperature that can help to predict the speed of the raising of the vehicle internal temperature, and can help to take action faster. In one embodiment, the venting sensor can provide information about the actual speed of the A/C fan which can confirm if the A/C works as expected.

System 100 typically further includes Alert Logic 140. Alert Logic 140 is configured to send an alert to a remote device based on the condition within the vehicle and the determination that a disabled person, child or animal is in the vehicle without a responsible person, e.g., without an adult. Alert Logic 140 may also be configured to send an alert regarding vehicle conditions, e.g., when a door is opened, sounds or voices are monitored inside the vehicle, air conditioning is turned on or off, when a window or sunroof is opened, when a person or animal leaves or enters the vehicle. For example, an alert may be sent when an animal or child jumps out of a window.

In some embodiments, the alerts can be, but not limited to, a text message, an email, a pop-up alert on a mobile device, a voice phone call, the vehicle's horn, operating the vehicle's lights, V2X notifications to a nearby vehicle, pedestrian, emergency service vehicle or infrastructure, by using Vehicle-to-Everything (V2X) technologies like, but not limited to, Vehicle-to-Vehicles (V2V), Vehicle-to-Pedestrians (V2P), Vehicle-to-Infrastructure (V2I), Vehicle-to-Cloud (V2C), Vehicle-to-Home (V2H), Vehicle-to-Device (V2D) and Vehicle-to-Network (V2N).

The alerts can be based on, but not limited to, a cell phone, LTE, 5G, satellite, Bluetooth, WiFi, LoRa/LoRaWAN or V2X communications that can send alerts and notifications using a cellular network or directly to a nearby vehicle, pedestrian, emergency vehicle or infrastructure even without a cellular network.

The alert logic can be based on predefined rules and/or user defined rules, or a mix of both. The rules can include, but not limited to, temperature thresholds, vehicle vent status, type of alert and notifications, the destination of the alerts and notifications, and the ways of the escalation of the alerts and notifications.

System 100 optionally further includes Venting Logic 150. Venting Logic 150 is configured to vent the vehicle based on the condition within the vehicle and the determination that a child or animal is in the vehicle without an adult.

The venting logic 150 may be configured to perform a variety of different actions. The actions can be used at least one action or a mix of all the actions. For example, but not limited to, lower the vehicle windows (fully or partially), open the sunroof, turn on the A/C system, and unlock/open the vehicle's doors. In a specific example, if an unattended pet is within the vehicle, Venting Logic 150 may be configured to lower windows 3 inches, e.g., enough to help cool the vehicle but not so much as to allow the pet to leave the vehicle. The amount of window lowering may be dependent on the identity of the vehicle occupant. The venting logic may also be configured to send notifications about the actual action that took place.

In case of using an After-Market device, the venting logic can communicate with the vehicle's systems by using different technologies like, but not limited to, Bluetooth, WiFi, LoRa/LoRaWAN, USB, or the On-Board Diagnostics II (OBD-II) port.

System 100 may further include an auxiliary power source 170 configured for the elements illustrated in FIG. 1 to operate independently of a power system of Vehicle 105. Auxiliary power source 170 may, for example, include a solar power source and/or a backup battery.

System 100 may further include an auxiliary Vehicle Controller 180 configured to execute logic within the vehicle. Vehicle Controller 180 may include a computing device, e.g., a microprocessor and/or circuit. Vehicle Controller 180 may control a user interface, an audio system, engine functions, door locks, navigation, self-driving features, wireless communications to other devices, and/or the like. In a specific example, Vehicle Controller 180 may control operation of windows or door locks.

System 100 may further include storage 190 configured to store any of the logic discussed herein, an occupant identifier, and/or data generated by occupant sensor 110 or Vehicle sensor 130. Storage 190 typically includes digital memory. Storage 190 may be disposed within occupant sensor 110, elsewhere within vehicle 105, and/or on a remote location such as a mobile device or cloud computing system.

System 100 typically further includes a (micro) processor 195 configured to execute any of the logic discussed herein. Processor 195 can include a circuit specifically configured to execute the logic or a general-purpose microprocessor specifically configured to execute the logic, e.g., a programmable logic circuit.

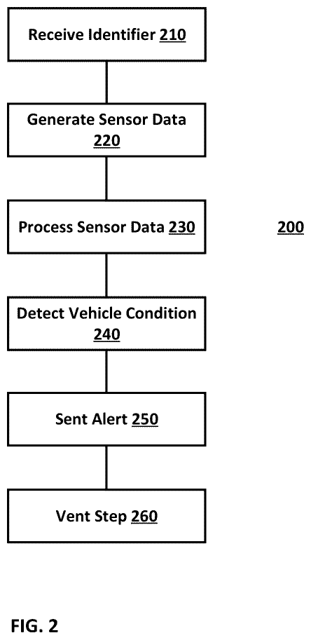

FIG. 2 illustrates a method 200 of monitoring vehicle occupants, according to various embodiments. In this method, if an unattended child or animal is detected in a vehicle an alert may be sent out and/or the vehicle may be automatically vented to control interior vehicle temperature.

In an optional Receive Identifier Step 210 an identifier of a person or animal to be monitored is received. The identifier may include, for example, a face scan, a photograph, a video, a thermal signature, an ultrasonic signature or a laser signature.

In different embodiments, the identifier can be provided in different ways. For example, parents can scan their child face using a an application on a mobile phone using the mobile phone camera, or a mother can upload an image of her child using her home computer to a cloud service that later will update the vehicle system with the data, or she can upload a sample video of her child directly to a USB port in the vehicle, or a father that will use the vehicle thermal sensor to sample a thermal signature of his child using the vehicle sensor while the child is sitting in the child car seat that in the vehicle, or a caregiver can use the vehicle ultrasonic sensor to get sample an ultrasonic signature of a disabled elderly that is sitting in the vehicle, or an animal owner can use the vehicle laser sensor to get a sample of a laser signature of his dog that is in the vehicle.

These features are only a few examples that show that a family can provide identifiers of all the family members and the system can recognize a specific child or adult, and a notification can also include which specific child is in the vehicle, or system rules that will be based on a specific family member.

These are only a few examples that show only some of the benefits that the system can recognize any human, adult or child, in any age. In addition, the same is with animals, the system is able to identify any animal, from any kind or age, and even a specific animal.

In a Generate Sensor Data Step 220 An occupant sensor is used to generate sensor data regarding an interior of a vehicle. The sensor can include any of the sensors discussed herein, for example any embodiment of or combination of Occupant Sensor 110. The sensor data can include any of the sensor data described elsewhere herein. For example, sensor data generated using Occupant Sensor 110. The occupant sensor can generate data continuously or based on schedule. The behavior of when the sensor is generating data can be predefined or a user defined, or a mix of both. The configuration should take into consideration the type of the sensor. Since the occupant sensor and the system are using the vehicle energy, there are situations that the occupant sensor and the system will be running, for example, but not limited to, to generate occupant sensor data only few times in a minute, or even only every few minutes.

In addition, from the natural idea of the occupant sensor, it will need to generate data even when the vehicle is parked, and the engine is not running for a gas (Internal Combustion Engine) vehicle or when an EV vehicle is offline and/or in sleeping mode.

In some embodiments, to make sure that the invention will provide data and send alerts even when the vehicle is offline, the system will need to be backed up by another power source, for example, but not limited to, a battery, a generator, a solar panel, and such.

In another embodiment, to support higher privacy, the occupant sensor can be configured to generate data only when the vehicle is stationary or in park mode.

In a Process Sensor Data Step 230 a trained machine learning system is used to process the sensor data generated in Generate Sensor Data Step 220. Typically, the machine learning system is trained to distinguish between adults, children and/or animals within the sensor data. In some embodiments, the machine learning system is trained to detect the person or animal based on the identifier received in Receive Identifier Step 210.

In some embodiments, processing the sensor data can result in prediction objects as adults, children and/or animals. In other embodiments, processing the sensor data can result in prediction objects as a specific person and/or animal. The prediction process can be based on a single machine learning model or a few different machine learning models. In some embodiments, the prediction will be based on the identifiers as discussed herein. These features are only a few examples that show that a family can provide identifiers of all the family members and the system can recognize a specific child or adult, and a notification can also include which specific child is in the vehicle, or system conditions that will be based on a specific family member.

Typically, a result of the processing in Process Sensor Data Step 230 includes a determination if a child or animal is in the vehicle without an adult. In some embodiments, the result may include a determination that a person or animal identified by the identifier received in Receive Identifier Step 210 is in the car.

In some embodiments, the results may include a determination for an adult that can be an elderly that has dementia and needs a watch, or a disabled adult that is left alone in the vehicle. In some embodiments, the results may include a determination that the occupant is located in a specific seat location. In some embodiments, the results may include a determination that a person will be identified by the age of the person. In some embodiments, the results may include a determination that more than one person was left alone, for example, but not limited to, two children that were left alone in a vehicle.

In some embodiments, the results can be based on more than one occupant sensors that are located in different locations. For example, a pickup truck that tow a trailer. One of the occupant sensors will be located in the pickup truck cabin and determine if someone is in the pickup truck itself, and another occupant sensor will be located in the trailer and will check if someone is in the trailer.

In some embodiments, the system may be configured to detect based on the amount of people and/or animals that are in the vehicle, or by specific identifiers, or by the age, or by the location in the vehicle, or a mix of these options.

Process Sensor Data Step 230 is optionally performed using Machine Learning System 120.

In an optional Detect Vehicle Condition Step 240, conditions within the Vehicle 105 are detected. These conditions can include temperature, window position, sunroof position, engine status, A/C status, fan status (operation), door lock status, and/or the like. The detection of the vehicle condition can help to understand the vehicle status inside and outside. The status can help to understand the situation better and help with taking decisions that are based on conditions that will help to take actions as discussed herein. Vehicle conditions can be learned by at least one sensor that is within the vehicle or outside the vehicle and/or that was added as an after-market sensor. Sensors can be from various types, when each type can provide different types of data. For example, sensors can be from type of, but not limited to, a temperature sensor, an A/C operation sensor, an A/C fan speed sensor, a vehicle acceleration sensor, a vehicle speed sensor, a vehicle parking sensor, a GPS location sensor, a sound sensor, a windows level sensor, a sunroof status sensor, a door lock sensor, a vehicle lights sensor, a vehicle parking status sensor, and an interior motion sensor. In some embodiments, Detect Vehicle Condition Step 240 includes detecting the status of a self-driving vehicle.

In one embodiment, when recognizing a human and/or an animal are unattended in the vehicle, the vehicle parking sensor can help to recognize if the vehicle is in parking mode. In another embodiment, when recognizing a human and/or an animal are unattended in an Autonomous vehicle, when there is no driver at all, the vehicle speed sensor can help to recognize if the vehicle is not moving. In another embodiment, after an earthquake or a storm, debris can be found on the road and can block the movement of an Autonomous taxi vehicle, the GPS sensor can help to recognize if the vehicle is not moving. In another embodiment, when recognizing a human and/or an animal are unattended in an Autonomous vehicle, and the Autonomous vehicle ended the navigation task and arrived at the destination, the vehicle door lock can determine that an unattended child didn't go out or picked up.

In an optional Send Alert Step 250 an alert is sent to a remote device, e.g., Client Device 145 and/or Server 147. Sending of an alert may be dependent on whether a disabled person, child or animal is present in the vehicle without an adult or other capable person. Alerts will be sent based on rules. The rules can be predefined, user-defined, or a mix of both. Alerts can be sent to different remote devices, for example, but not limited to, a smartphone, computer, landline, smartwatch, tablet, another vehicle and authorities infrastructure.

Alerts can be from various types, for example, but not limited to, a text message, an email, a pop-up alert on a mobile device, a voice phone call, the vehicle's horn, operating the vehicle's lights, an audio message generated outside the vehicle using a speaker, V2X notifications to a nearby vehicle, pedestrian, emergency service vehicle or infrastructure. The alerts can be based on different types of technologies, for example, but not limited to, a cell phone, LTE, 5G, satellite, Bluetooth, WiFi, LoRa/LoRaWAN or V2X communications that can send the alerts using a cellular network or directly to a nearby vehicle, pedestrian, emergency vehicle or infrastructure even without a cellular network. An alert may be sent when an unaccompanied child is present in a moving, stopped and/or parked driverless vehicle. Such alert may prevent the vehicle from traveling to prevent use of the driverless vehicle by unaccompanied children or minors. An alert may be sent if an infant is detected in the vehicle and not in a proper child seat or restraint. For example, if the vehicle is moving and an unrestrained 2 year old child is detected in the back seat, this may cause alert logic 140 to issue an alert.

Alerts can include information that can help to understand the situation in the vehicle, for example, but not limited to, if a child is alone, an interior image and/or video, amount of persons and/or animals that are in the vehicle, person and/or animal condition, an identification of a specific person and/or animal, interior temperature, exterior temperature, vehicle vent status, GPS location, the destination of the alerts and notifications, and the ways of the escalation of the alerts and notifications. Alerts may be sent using Alert Logic 140.

In an optional Vent Step 260 a venting operation is performed. The venting operation may be dependent on whether a disabled person, child or animal is present in the vehicle without an adult or other capable person. The venting operation may include, for example, turning on air conditioning, lowering a window, opening a door, opening a sunroof, or turning on a fan. In a specific example, a venting operation may include lowering windows by 2, 3 or 4 inches or opening windows completely. Vent Step 260 may be performed using Vehicle Controller 180. The venting operation may be dependent on characteristics of the detected vehicle occupants. For example, a window may be lowered only a few inches if an animal is present in a vehicle to avoid letting the animal loose. If a window is lowered, the venting operation may also include manual locking operation of door locks such that a person cannot reach through the lowered window and unlock the door.

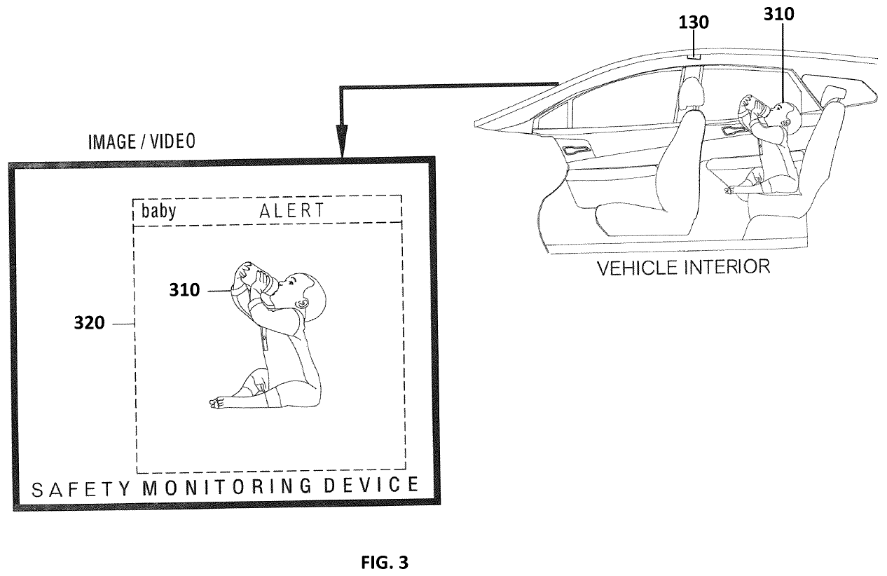

FIG. 3 illustrates display of a vehicle occupant 310 on a Screen 320 of a mobile device, according to various embodiments of the invention. The occupant sensor 110 may disposed in locations other than that shown and can include any of the types of occupant sensors 110 discussed herein. The occupant 310 may be classified as an infant that requires a particular type of child seat and the proper use of the child seat may be detected using occupant sensor 110 and machine learning system 120. In some embodiments, alert logic 140 is configured to activate or deactivate airbags and/or other automated restraint systems.

Vehicle sensor 130 and/or occupant sensor 110 may be powered by a power system of the vehicle, by a battery or other power storage device directly connected to occupant sensor 110, and/or by a solar power source. In some embodiments, vehicle sensor 130 and/or occupant sensor 110 are configured to attach to and receive power from an interior vehicle light, e.g., a dome light. Specifically, vehicle sensor 130 may be configured to receive power from a light socket directly or using a plug-in adaptor. Occupant sensor 130 may be configured as a replacement for an interior light source, e.g., a bulb and/or a bulb housing. I/O 160 is optionally integral to occupant sensor 110 or may be disposed elsewhere within the vehicle. Vehicle Sensor 130 optionally includes a dashcam.

Vehicle sensor 130, occupant sensor 110, and/or machine learning system 120 are optionally configured to detect hazardous objects within the vehicle. Information (e.g., images) gathered using vehicle sensor 130 and/or occupant sensor 110 are optionally communicated using a vehicle assistant system such as OnStar™ or using a personal assistant such as Alexia™. In some embodiments occupant sensor 110 is configured to move its field of view. For example, a camera may be configured to move to scan various parts of a vehicle's interior.

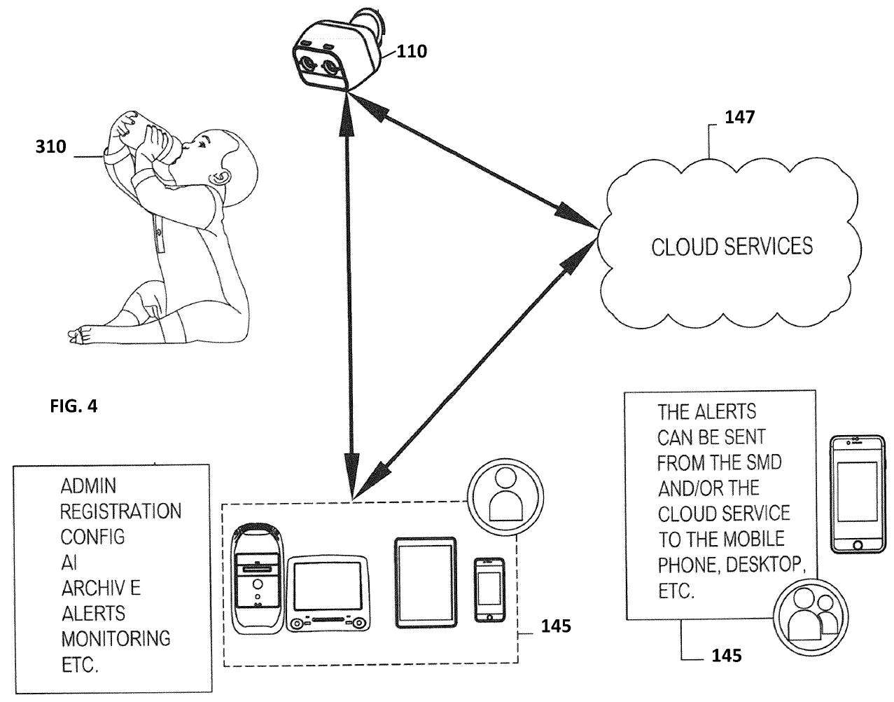

FIG. 4 illustrates communication between a vehicle camera, mobile devices and cloud services, according to various embodiments of the invention. The embodiments of system 100 illustrated in FIG. 4 can include functions such as but not limited to account registration and setup (contact information, subscription payments, notification preferences, etc.); alert rule customizing, operating parameters, (choosing the area that should be monitored, choosing who the system should detect: baby, child, adult, etc., should the system look for a baby getting far from an adult, set the distance that should consider as “far,” set the sensitivity of the system for some of the parameters, schedule operations like when to start and stop detecting, how long to remain active, when to engage local area networks and transmit data, etc.), training options for various scenario detections, and status (which occupant sensors 110 and/or vehicle sensors 130 are collecting data, problems, calibrations, etc.).

Several embodiments are specifically illustrated and/or described herein. However, it will be appreciated that modifications and variations are covered by the above teachings and within the scope of the appended claims without departing from the spirit and intended scope thereof. For example, while the examples discussed herein include detection of vehicle occupants, the systems and methods may be adapted to other enclosed spaces such as vaults, elevators, saunas, refrigeration units, trailers, and/or the like.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

The “logic” discussed herein is explicitly defined to include hardware, firmware or software stored on a non-transient computer readable medium, or any combinations thereof. This logic may be implemented in a quantum, electronic and/or digital device (e.g., a circuit) to produce a special purpose computing system. Any of the systems discussed herein optionally include a microprocessor, including quantum, electronic and/or optical circuits, configured to execute any combination of the logic discussed herein. The methods discussed herein optionally include execution of the logic by said microprocessor.

What is claimed is:

1. A vehicle monitoring and safety system, the system comprising:
an occupant sensor configured to generate sensor data regarding occupants of a vehicle;
a trained machine learning system configured to process the sensor data to distinguish between adults, children and animals within the vehicle, a result of the processing including a determination if a child or animal is in the vehicle without an adult, the machine learning system optionally being configured to distinguish a specific occupant based on an identifier of a specific person or animal;
a vehicle sensor configured to detect at least one condition within the vehicle, the condition including at least interior vehicle temperature and/or venting status;
optional alert logic configured to send an alert to a remote device based on the condition within the vehicle and the determination that a child or animal is in the vehicle without an adult; and
optional venting logic configured to vent the vehicle based on the condition within the vehicle and the determination that a child or animal is in the vehicle without an adult.

2. A method of monitoring vehicle occupants, the method comprising:
optionally receiving an identifier of a person or animal to be monitored, the identifier optionally including a photograph;
using an occupant sensor to generate sensor data regarding an interior of a vehicle, wherein the sensor can include at least one of a camera, an ultrasonic sensor, an infrared sensor, a lidar sensor or a radar sensor;
using a trained machine learning system to process the sensor data, the machine learning system being trained to distinguish between adults, children and/or animals within the sensor data, the machine learning system optionally being trained to detect the person or animal based on the identifier, a result of the processing including a determination if a child or animal is in the vehicle without an adult;
optionally detecting a condition of the vehicle, the condition including at least one of: interior vehicle temperature, and venting status;
if a child or animal is present in the vehicle without an adult, optionally performing a venting operation; and
if a child or animal is present in the vehicle without an adult optionally sending an alert to a remote device.

3. The system of claim 1, wherein the sensor data comprises one or more images and/or videos, and/or thermal images, and/or radar signals, and/or ultrasonic signals, and/or laser signals.

4. The system of claim 1, wherein the occupant sensor includes one or more of a camera, ultrasonic sensor, infrared sensor, lidar sensor, radars or motion sensor.

5. The system of claim 1, wherein the occupant sensor includes a power source independent of a power source of the vehicle.

6. The system of claim 1, wherein the vehicle sensor is configured to monitor interior vehicle temperature and a position of windows of the vehicle.

7. The system of claim 1, further comprising a vehicle controller configured to operate windows and/or a fan of the vehicle in a venting operation, responsive to an output result of the trained machine learning system.

8. The system of claim 1, wherein the identifier includes a photograph of the specific person or animal.

9. The system of claim 1, wherein the trained machine learning system is disposed on a computing device remote from the vehicle.

10. The system of claim 1, further comprising detecting one or more unattended humans and/or animals who require supervision based on one or more predefined rules.

11. The system of claim 1, further comprising detecting one or more unattended humans and/or animals who require supervision based on one or more user-defined rules.

12. The system of claim 1, wherein the alert is sent to a remote device of a member of a user-defined contact list.

13. The system of claim 1, wherein the alert is configured to cause one or more of an alarm, a sound, vehicle horn operation, vehicle light operation, sending a text message, generating a pop-up message, sending a push-notification, or initiating a phone call to a remote device.

14. The method of claim 2, further comprising customizing one or more recognition capabilities, wherein the one or more recognition capabilities are configured to recognize a specific human and/or animal.

15. The method of claim 2, further comprising customizing one or more recognition capabilities, wherein the one or more recognition capabilities are configured to estimate a human age and/or age range.

16. The system of claim 1, further including an I/O configured to communicate the alert via at least one of a wired network, a wireless network, a cellular network and a satellite network.

17. The system of claim 1, wherein the sensor includes a camera, radar sensor or lidar sensor configured to detect at least one of a person, a face and breathing.

18. The system of claim 1, wherein the venting of the vehicle includes at least one of opening a window, turning on a fan, unlocking a door, opening a door or opening a sunroof/moonroof.

19. The method of claim 2, wherein the alert includes at least one of a vehicle location, a vehicle interior temperature or a vehicle interior image.

20. The system of claim 1, wherein an unattended human and/or animal, can be considered unattended even if another human and/or animal is nearby but not within the vehicle.

21. The system of claim 1, wherein the trained machine learning system is configured to distinguish between the presence of 1) both an adult and a child in the vehicle and 2) the presence of only one or more children in the vehicle, and operation of the alert logic and/or venting logic being responsive to the presence of only one or more children in the vehicle.

22. The system of claim 1, wherein the trained machine learning system is configured to distinguish between 1) the presence of both an adult and an animal in the vehicle and 2) the presence of only one or more animals in the vehicle, and operation of the alert logic and/or venting logic being responsive to the presence of only one or more animals in the vehicle.

23. The system of claim 1, wherein a type of venting performed by the venting logic using the vehicle controller is dependent on an identity of a child and/or an animal within the vehicle.
